(19) United States
(12) Patent Application Publication
(10) Pub. No.: US 2012/0262543 A1
(43) Pub. Date: Oct. 18, 2012

(54) METHOD FOR GENERATING DISPARITY MAP OF STEREO VIDEO

(75) Inventors: Kun-ting Lee, Xianxi Township (TW); Bing-yu Chen, Taipei City (TW); Sheng-chi Liu, Xindien City (TW); Che-wei Chang, Daxi Township (TW); Hsiu-hung Lin, Sanxia Township (TW)

(73) Assignees: Chunghwa Picture Tubes, Ltd., Bade City (TW); National Taiwan University, Taipei City (TW)

(21) Appl. No.: 13/176,767

(22) Filed: Jul. 6, 2011

(30) Foreign Application Priority Data
Apr. 13, 2011 (TW) 100112823

(51) Int. Cl. H04N 13/00

(52) U.S. Cl. 348/43; 348/E13.064

(57) ABSTRACT

The present invention utilizes determining the similarity between two adjacent frames to accelerate the computation of disparity maps of a stereo video. In a first stage, color similarity of pixels between the two adjacent frames is estimated. In a second stage, a plurality of feature points is selected from a previous frame, then the corresponding positions is located in a next frame for the feature points, and an average displacement of the feature points between the previous and the next frames is estimated. If the two adjacent frames are determined to be similar, the disparity map of the next frame can be obtained according to the disparity map of the previous frame. In such a manner, the computation of disparity maps of the stereo video can be accelerated.

### TECHNICAL FIELD OF THE INVENTION

The present invention relates to a method for generating disparity maps of a stereo video, and more particularly, to a method capable of accelerating the computation of disparity maps of the stereo video.

### BACKGROUND OF THE INVENTION

At present, a stereoscopic imaging is mostly fulfilled by utilizing a parallax effect. By providing a left image for a left eye and a right image for a right eye, it is possible to convey a 3D impression to a viewer when the viewer is watching the images at an appropriate viewing angel. A two-view stereoscopic video is a video generated by utilizing such an effect and each frame of the video includes an image for a left eye and another image for a right eye. The depth information of objects in the frame can be obtained by processing the two-view stereoscopic video. The depth information for all pixels of the image constructs a disparity map. The two-view stereoscopic video can be further rendered into a multi-view stereoscopic video by using the disparity maps.

However, the construction of the disparity maps or depth relation maps is an extremely time-consuming work. When processing the two-view stereoscopic video, the calculation load is very heavy since each frame has to be computed to obtain a corresponding disparity map. Among the conventional skills, the most precise or accurate disparity map is achieved or developed by Smith et al. with the published article, “Stereo Matching with Nonparametric Smoothness Priors in Feature Space”, CVPR 2009. However, the disadvantage of this art is that it takes a long computation time. For a two-view stereoscopic video picture having a left image and a right image of with a resolution of 720×576, the computation of the disparity map takes about two to three minutes. When it needs to compute the disparity maps of all the frames in the two-view stereoscopic video, the cost of computation will be very high.

Some algorithms for computing the disparity maps can reach a faster speed but the accuracy is not good enough. Among the conventional skills, an approach that achieves the fastest speed and an acceptable accuracy is provided by Gupta and Cho with the published article, “Real-time Stereo Matching using Adaptive Binary Window”, 3DPVT 2010. The calculation speed of this art can reach five seconds per frame but the obtained disparity map is still quite inaccurate. However, a high accurate disparity map is usually required in composition of a stereo video. The disparity map obtained by utilizing this conventional art is too rough such that errors often occur in the subsequent image composition.

Therefore, how to improve the efficiency of the disparity map calculation of the stereo video and maintain the accuracy of the disparity map in the meanwhile is an important issue in this field.

### SUMMARY OF THE INVENTION

An objective of the present invention is to provide a method for generating disparity maps of a stereo video to accelerate the computation of disparity maps of the stereo video.

To achieve the above objective, the present invention provides a method for generating disparity maps of a stereo video, where the stereo video is a video stream constructed at least by a first frame and a second frame next to the first frame, and the method comprises steps of: utilizing a predetermined algorithm to compute a first disparity map corresponding to the first frame; calculating an average color difference of pixels between the first frame and the second frame; selecting a plurality of feature points from the first frame, locating corresponding positions in the second frame for the feature points, respectively, and calculating an average displacement of the feature points between the first frame and the second frame; and obtaining a second disparity map corresponding to the second frame based on the first disparity map and the corresponding positions in the second frame for the feature points when the average color difference is less than a first threshold value and the average displacement is less than a second threshold value, otherwise, utilizing the predetermined algorithm to compute the second disparity map.

In the present invention, it can utilize the disparity map of the previous frame to estimate the disparity map of the next frame for some similar images and the calculation load required by this approach is much less than that required by utilizing the predetermined algorithm to compute the disparity map. Therefore, the present invention can reduce the computation time for computing the disparity maps of a stereo video and thereby accelerating the speed of the disparity map computation. After performing a few tests, there are at least 55% of images that can use an optical flow technique to accelerate the computation of depth values and thereby greatly increasing the speed to compute the depth information for the whole video.

### BRIEF DESCRIPTION OF THE DRAWINGS

The present invention will be described in details in conjunction with the appending drawings.

FIG. 1 is a flow chart illustrating a method for generating disparity maps of a stereo video according to the present invention.

FIG. 2 is a flow chart illustrating a way to determine a threshold value of an average color difference of pixels between two adjacent frames in the present invention.

FIG. 3 is a flow chart illustrating a way to determine a threshold value of an average displacement of pixels between two adjacent frames in the present invention.

FIG. 4 is a flow chart illustrating utilizing an optical flow technique and a disparity map of a previous frame to estimate the disparity map of a next frame in the present invention.

FIG. 5 is a diagram illustrating utilizing interpolation to obtain vectors of an encompassed pixel in the present invention.

### DETAILED DESCRIPTION OF THE INVENTION

In a two-view stereoscopic video stream, each video frame includes a left image for a left eye and a right image for a right eye. It is an extremely time-consuming work to compute depth relations from the two-view stereoscopic information. In the present invention, in consideration of the inherent time coherence of a video, the computation of disparity maps of a stereo video is accelerated by determining the similarity between two adjacent frames, i.e. a previous frame and a next frame adjacent to the previous frame. In determining the similarity between two adjacent frames, two stages are adopted in the present invention. In a first stage, color similarity of pixels between the two adjacent frames is estimated. In a second stage, a plurality of feature points is selected from the previous frame, the corresponding positions for the feature points are located in the next frame, respectively, and the displacement of the feature points between the two adjacent frames is estimated. If the two adjacent frames are determined to be similar, the disparity map of the next frame can be obtained according to the disparity map of the previous frame. In such a manner, the computation of disparity maps of the stereo video is accelerated. When accompanying with the obtained disparity maps, a two-dimensional video can be displayed with a 3D display technique to generate a 3D effect. Also, the two-view stereoscopic video can be further rendered into a multi-view stereoscopic video by using the disparity maps. The rendering manner is called a depth image based rendering.

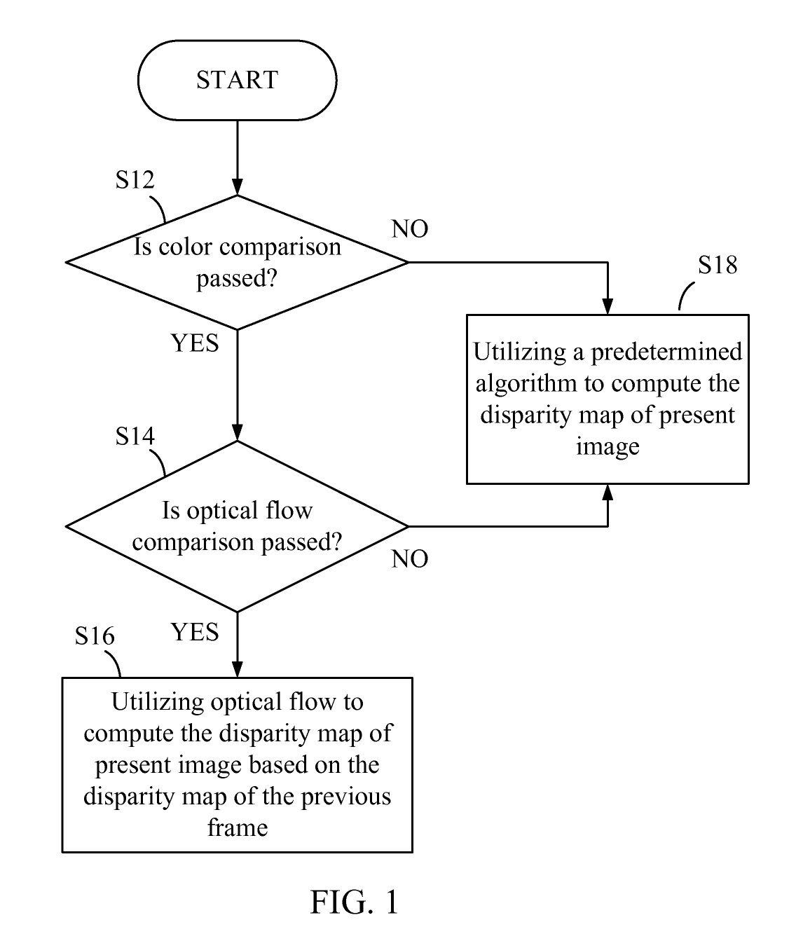

FIG. 1 is a flow chart illustrating a method for generating disparity maps of a stereo video according to the present invention. Firstly, in Step S12, color comparison between two adjacent frames (i.e., a previous frame and a next frame adjacent thereto) in the stereo video is executed. An average color difference of pixels between the previous and the next frames is calculated for estimating the color similarity. If the color similarity of the two images is determined to be high, another comparison will be executed in next stage, (i.e., Step S14). In Step S14, a plurality of feature points is selected from the previous frames. An optical flow technique is utilized to locate the corresponding positions in the next frame for the feature points, respectively, and calculate an average displacement of the feature points between the previous and the next frames for determining the motion or displacement degree of objects in the previous and the next frames. It represents that the two images are similar if the color similarity of the two images is determined to be high and the average displacement of the feature points is determined to be small. That is, the comparisons in Step S12 and Step S14 are passed. Then, as indicated in Step S16, the disparity map of the next frame can be correspondingly obtained based on the disparity map of the previous frame and the corresponding positions in the next frame for the feature points (selected from the previous frame). In the color comparison of Step S12, if the color similarity of the two adjacent frames is determined to be low, i.e. the average color difference is too high, it needs to re-compute the disparity map of the next frame. Specifically, a predetermined algorithm is utilized to compute a disparity map that is more precise, as indicated in Step S18. In the displacement comparison of Step S14, if the motion or displacement degree of an object in the two adjacent frames is determined to be drastic, i.e. the average displacement of the feature points is too high, it needs to utilize the predetermined algorithm to compute the disparity map of the next frame. That is, if any one of Step S12 and Step S14 comparisons is not passed, then it needs to utilize the predetermined algorithm to compute the disparity map. In this embodiment, the color comparison of Step S12 is executed in advance. The displacement comparison of Step S14 is executed after Step S12 is passed. This is because the calculation load required by computing the color difference is much less than that required by the optical flow technique. It does not need to execute the displacement comparison if the color difference between the two adjacent frames is determined to be sufficiently great. Therefore, whether to compute the disparity map with the predetermined algorithm can be determined in a short time. In addition, the aforesaid predetermined algorithm can be implemented by the algorithm developed by Smith et al. so as to compute the most precise disparity map as known for now. In addition, the present invention is not limited to the color comparison of Step S12 and the displacement comparison of Step S14 since other approaches can also be placed into this framework as well to accelerate the computation of the disparity maps.

In the color comparison of Step S12, the color difference of pixels between the adjacent frames is calculated as represented by the following equations.

$$\begin{matrix}{E}_{color} = \frac{{\sum }_{{I}_{t} ( x , y )} d ( {I}_{t - 1} ( x , y ) , {I}_{t} ( x , y ) )}{{N}_{pixel}} & ( 1 ) \\ d ( P , Q ) = \vert Pr - Qr \vert \times 0.3 + \vert Pg - Qg \vert \times 0.59 + \vert Pb - Qb \vert \times 0.11 & ( 2 )\end{matrix}$$

where E_{color} represents an average color difference, Iₜ(x, y) is a pixel at a time point t and located at a position (x,y), Nₚᵢₓₑₗ is the number of pixels for one image, P and Q represent the pixels located at the same position for two adjacent frames, and the subscripts r, g, and b of P and Q respectively represent a red value, a green blue, and a blue value for the two pixels P and Q. The present invention is not limited to the above approach since other approaches also can be utilized to calculate the average color difference of pixels between the adjacent frames.

After the average color difference of all the pixels between the two adjacent frames is calculated by using the aforesaid approach, the average color difference is then compared to a first threshold value. When the average color difference is less than the first threshold value, the color similarity of the two images is determined to be high. That is, the color comparison of Step S12 is passed and then another comparison is continued in a next stage, i.e., the displacement comparison of Step S14. When the average color difference is larger than the first threshold value, the color similarity of the two images is determined to be low. That is, the color comparison of Step S12 is not passed. In this situation, it does not need to execute the displacement comparison of Step S14 and should directly enter Step S18 to adopt the predetermined algorithm to compute the disparity maps.

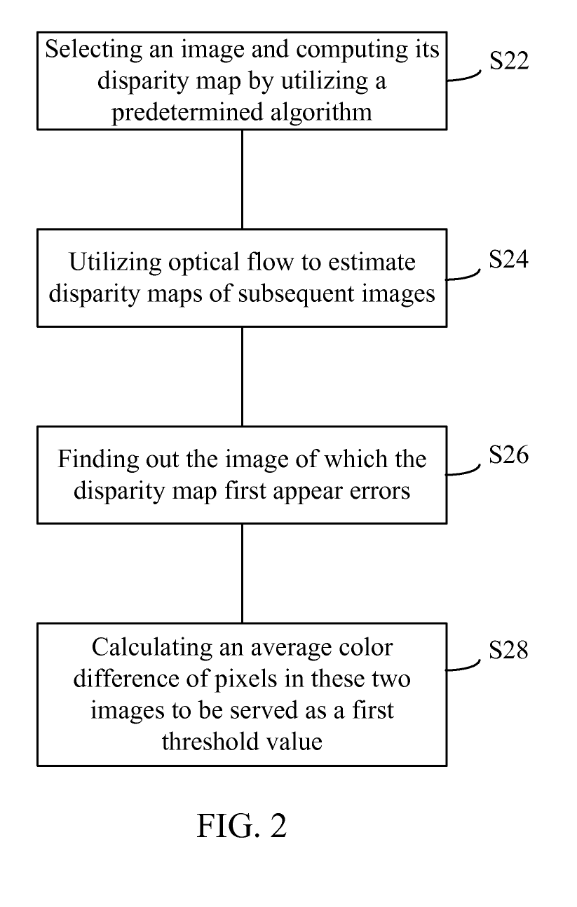

Further referring to FIG. 2, the first threshold value can be determined by the following approach.

Step S22: Firstly, an image of a stereo video is selected and the predetermined algorithm is adopted to compute a disparity map of the image, wherein the adopted algorithm can come out a disparity map that is more precise.

Step S24: A plurality of feature points is selected from the selected image. Then, an optical flow technique is utilized to locate the corresponding positions in a next frame for the feature points and the disparity map of the selected image is utilized to estimate the disparity map of the next frame and to estimate the disparity maps of subsequent images based on the disparity map of a previous frame.

Step S26: The image of which the disparity map first appears errors is found out from the disparity maps of the subsequent images and then taking out the image that the disparity map first appears errors.

Step S28: The above equations (1) and (2) are utilized to calculate the average color difference of pixels between the selected image and the image that the disparity map first appears errors. This average color difference is to be served as the first threshold value.

After undergoing experiments repeatedly, utilizing the optical flow technique and the disparity map of the previous frame to estimate the disparity of the next frame will result in a higher error rate if the average color difference (E_{color}) of pixels between the two adjacent frames exceeds five. As a result, if the average color difference (E_{color}) of pixels between the two adjacent frames exceeds the first threshold value (i.e., 5), it should utilize the predetermined algorithm to compute the disparity map in a precise manner. After performing a few tests, on an average, there are 20% of the images in a two-view stereo video that have to use the predetermined algorithm to compute the disparity map through the color comparison of Step S12.

The color comparison of Step S12 has two main objectives. One is for accelerating the speed to determine whether the disparity map is needed to be calculated by using the predetermined algorithm. The calculation of color difference is faster than that of the optical flow and thus the color comparison is adopted in the beginning. The second objective is that it is inappropriate for merely utilizing the displacement comparison of Step S14 to determine whether the disparity map is needed to be calculated by using the predetermined algorithm or not when the color difference of two adjacent images is determined to be sufficiently great, for example, the camera is fast moved or the scene is translated. This is because the optical flow may not be able to come out the displacement of each pixel accurately and an accurate calculation may not be obtained when the scene is translated or the camera is fast moved. Therefore, it is necessary to use the color difference calculation to make an enhancement for determining whether the disparity map is needed to be calculated by using the predetermined algorithm.

If the color comparison of Step S12 is passed, the displacement comparison of Step S14 will be executed. In the displacement comparison of Step S14, a plurality of feature points is selected from the previous frame, the optical flow technique is utilized to locate the corresponding positions in the next frame for the feature points, respectively, and calculate the displacement of these feature points between the previous and the next frames. The optical flow technique adopted herein is Lucas-Kanade algorithm as indicated by an equation listed below.

$${E}_{motion} = \frac{{\sum }_{p} dist ( p )}{{N}_{feature}} , \qquad ( 3 )$$

where Eₘₒₜᵢₒₙ represents an average displacement of the feature points between two adjacent frames, dist(p) is a length of a feature vector corresponding to each feature point, and N_{feature} is a number of the feature vectors. The present invention is not limited to the above approach since other approaches also can be utilized to calculate the average displacement of the feature points between two adjacent frames. In the step of selecting feature points from the previous frame, it can be utilized to select one feature point from every two pixels. Also, all the pixels can be served as the feature points but selecting one feature point from several pixels has the benefit of calculation acceleration.

After the average displacement of the feature points between the two adjacent frames is calculated by using the aforesaid approach, the average displacement is then compared to a second threshold value. When the average displacement is less than the second threshold value, the motion or displacement degree of objects in the two adjacent frames is determined to be low. That is, the displacement comparison of Step S14 is passed and then the procedure goes to Step S16. That is, the corresponding positions in the next frame for the feature points (selected from the previous frame) obtained by using the optical flow technique and the disparity map of the previous frame are utilized to obtain the disparity map of the next frame correspondingly. When the average displacement is larger than the second threshold value, the position variation of an object in the two adjacent frames is determined to be high. Therefore, the displacement comparison of Step S14 is not passed. It should enter Step S18 to adopt the predetermined algorithm to compute the disparity maps.

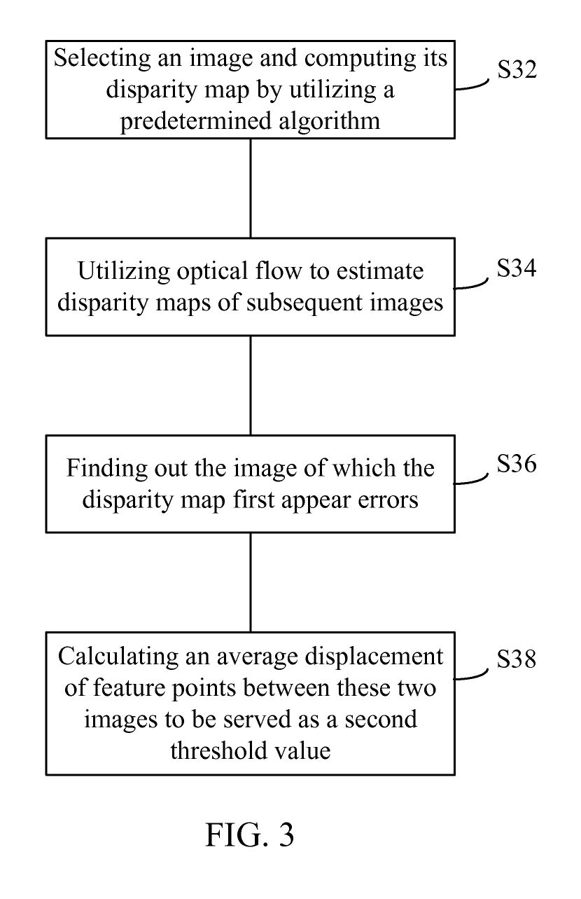

Further referring to FIG. 3, the second threshold value can be determined by utilizing the following approach.

Step S32: Firstly, an image of a stereo video is selected and the predetermined algorithm is adopted to compute a disparity map of the image, wherein the adopted algorithm can come out a disparity map that is more precise.

Step S34: A plurality of feature points is selected from the selected image. Then, an optical flow technique is utilized to locate the corresponding positions in a next frame for the feature points and the disparity map of the selected image is utilized to estimate the disparity map of the next frame and to estimate the disparity maps of subsequent images based on the disparity map of a previous frame.

Step S36: The image of which the disparity map does not meet the expectation is found out from the disparity maps of the subsequent images and then taking out the image that the disparity map does not meet the expectation.

Step S38: The above equation (3) is utilized to calculate the average displacement of the feature points between the selected image and the image that the disparity map does not meet the expectation. This average displacement is to be served as the second threshold value.

After undergoing experiments repeatedly, the second threshold value is 2.1. Utilizing the optical flow technique and the disparity map of the previous frame to estimate the disparity map of the next frame will result in a higher error rate if the average displacement (Eₘₒₜᵢₒₙ) of the feature points between the two adjacent frames exceeds 2.1. As a result, if the average displacement (Eₘₒₜᵢₒₙ) of the feature points between the two adjacent frames exceeds the second threshold value (i.e., 2.1), it should utilize the predetermined algorithm to compute the disparity map in a precise manner. After performing a few tests, the images filtered out by the displacement comparison of Step S14 that have to use the predetermined algorithm to compute the disparity map may occupy the whole video by about 25%. When adding the images filtered out by the color comparison of Step S12 (20%), the ratio of the images that have to use the predetermined algorithm to the whole video would be 45%. That is, there are at least 55% of images that can use the optical flow to accelerate the computation of depth values in the subsequent step, i.e., Step S16, and thereby greatly increase the speed to compute the depth information for the stereo video.

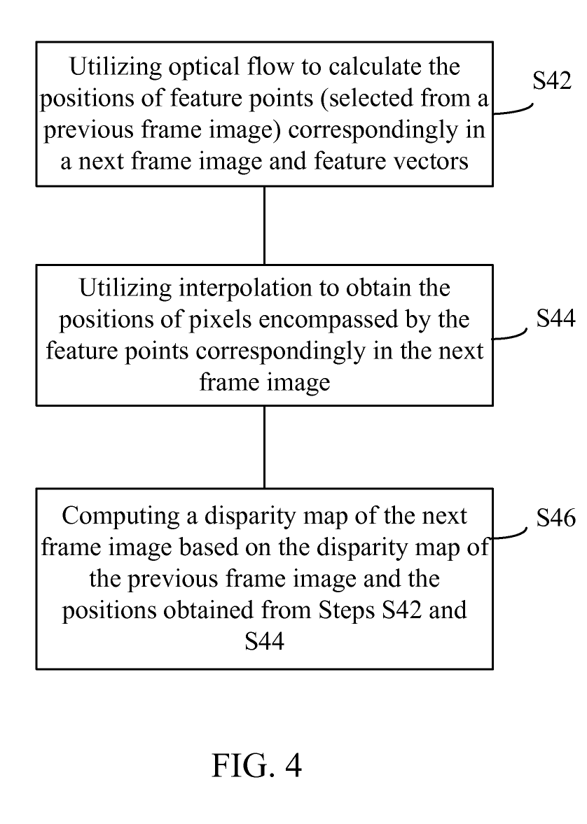

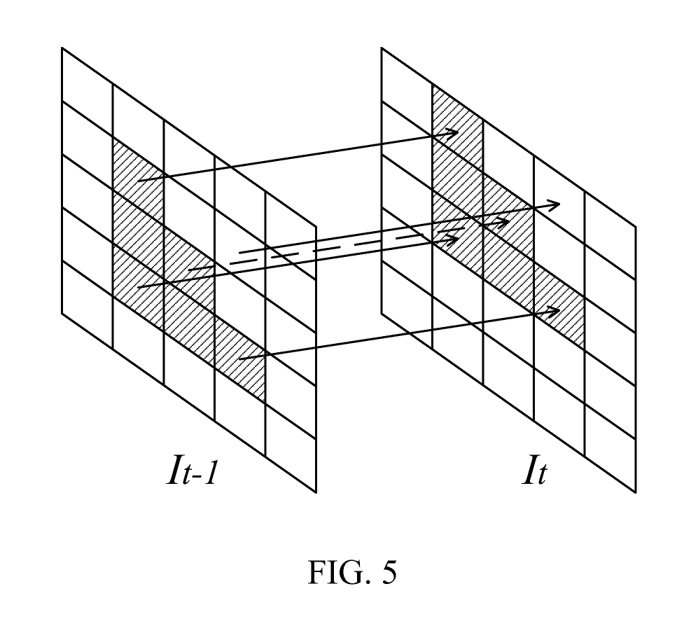

It represents that the two adjacent frames are similar if the color comparison of Step S12 and the displacement comparison of Step S14 are passed. In this situation, it can utilize the optical flow and the disparity map of the previous frame to estimate the disparity map of the next frame, otherwise, it has to utilize the predetermined algorithm to compute the disparity map. Referring to FIG. 4 and FIG. 5, the following detailed descriptions will indicate how to use the optical flow to estimate the disparity map as shown in Step 16 of FIG. 1.

Step S42: Firstly, the feature points selected from the previous frame (Iₜ₋₁(x, y)) (one feature point is selected from every two pixels, as shown in FIG. 5) is used, and the optical flow is utilized to calculate the corresponding positions in the next frame (Iₜ(x, y)) for the feature points, respectively, and calculate the feature vectors (as indicated by solid lines and arrows in FIG. 5) corresponding to the feature points.

Step S44: In FIG. 5, some pixels in the previous frame are not selected as the feature points but it still can utilize an interpolation manner to obtain the positions of these pixels correspondingly in the next frame. The vectors (as indicated by dash line and arrows in FIG. 5) of the pixels encompassed by the feature points can be obtained by interpolating the feature vectors of the feature points. In such a manner, the respective positions of the encompassed pixels correspondingly in the next frame can be obtained. The interpolation manner can be implemented by a bilinear interpolation.

Step S46: The depth values of the feature points in the previous frame are mapped to the corresponding positions (obtained from Step S42) in the next frame for the feature points, respectively. Also, the depth values of the encompassed pixels in the previous frame are mapped to the respective positions (obtained from Step S44) of the encompassed pixels correspondingly in the next frame. Therefore, the disparity map of the next frame can be correspondingly obtained based on the disparity map of the previous frame and the corresponding positions in the next frame for both the feature points and the encompassed pixels.

In the aforesaid manner, the calculation load required by utilizing the optical flow technique and the disparity map of the previous frame to estimate the disparity map of the next frame is much less than that required by utilizing the predetermined algorithm to compute the disparity map. Therefore, the present invention can reduce the computation time for computing the disparity maps of the stereo video and thereby accelerating the speed of the disparity map computation.

In addition, it is inevitable that defects such as holes will occur when utilizing the optical flow technique and the disparity map of the previous frame to estimate the disparity map of the next frame. When a hole has occurred in some regions of the disparity map of the next frame, a repair step can be implemented by locating the pixel corresponding to the hole in the next frame, selecting the pixel that has a most similar color from surrounding pixels (e.g., the surrounding pixels in a 3×3 area), and adopting a depth value of the pixel that has the most similar color as the depth value of the pixel corresponding to the hole.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A method for generating disparity maps of a stereo video, where the stereo video is a video stream constructed at least by a first frame and a second frame next to the first frame, the method comprising steps of:
utilizing a predetermined algorithm to compute a first disparity map corresponding to the first frame;
calculating an average color difference of pixels between the first frame and the second frame;
selecting a plurality of feature points from the first frame, locating corresponding positions in the second frame for the feature points, respectively, and calculating an average displacement of the feature points between the first frame and the second frame; and
obtaining a second disparity map corresponding to the second frame based on the first disparity map and the corresponding positions in the second frame for the feature points when the average color difference is less than a first threshold value and the average displacement is less than a second threshold value, otherwise, utilizing the predetermined algorithm to compute the second disparity map.

2. The method according to claim 1, wherein the determination of whether the average color difference is less than the first threshold value is performed prior to the determination of whether the average displacement is less than the second threshold value.

3. The method according to claim 1, wherein the average displacement is calculated by utilizing an optical flow technique.

4. The method according to claim 3, wherein the optical flow technique is represented in an equation listed below:
$${E}_{motion} = \frac{{\sum }_{p} dist ( p )}{{N}_{feature}} ,$$
where Eₘₒₜᵢₒₙ represents the average displacement of the feature points between the first frame and the second frame, dist(p) is a length of a feature vector corresponding to each feature point, and N_{feature} is a number of the feature vectors.

5. The method according to claim 1, wherein the first threshold value is determined by following steps:
selecting an image and computing a disparity map of the image based on the predetermined algorithm;
utilizing an optical flow technique and the disparity map of the image to estimate the disparity maps of subsequent images based on the disparity map of a previous frame and finding out the image that the disparity map first appears errors; and
calculating the average color difference of pixels between the selected image and the image that the disparity map first appears errors to be served as the first threshold value.

6. The method according to claim 1, wherein the second threshold value is determined by following steps:
selecting an image and computing a disparity map of the image based on the predetermined algorithm;
utilizing an optical flow technique and the disparity map of the image to estimate the disparity maps of subsequent images based on the disparity map of a previous frame and finding out the image that the disparity map first appears errors; and
selecting a plurality of feature points from the selected image, locating corresponding positions for the feature points in the image that the disparity map first appears errors, and calculating the average displacement of the feature points between the selected image and the image that the disparity map first appears errors to be severed as the second threshold value.

7. The method according to claim 1, wherein the step of obtaining the second disparity map of the second frame based on the first disparity map of the first frame comprises sub-steps of:
utilizing the feature points selected from the first frame to calculate the corresponding positions in the second frame for the feature points and calculate the feature vectors corresponding to the feature points;
utilizing an interpolation manner to interpolate the feature vectors of the feature points to estimate vectors of the pixels encompassed by the feature points and in such manner that respective positions of the encompassed pixels correspondingly in the second frame is obtained; and
obtaining the second disparity map of the second frame correspondingly based on the first disparity map of the first frame and the corresponding positions in the second frame for both the feature points and the encompassed pixels.

8. The method according to claim 7, wherein the interpolation manner is a bilinear interpolation.

9. The method according to claim 1, wherein when a hole has occurred in some regions of the second disparity map of the second frame, a repair step is utilized to locate the pixel corresponding to the hole in the second frame, select the pixel that has a most similar color from surrounding pixels, and adopt a depth value of the pixel that has the most similar color as the depth value of the pixel corresponding to the hole.

10. The method according to claim 1, wherein the stereo video is a two-view stereoscopic video.
